(19) United States
(12) Patent Application Publication
(10) Pub. No.: US 2020/0083589 A1
(43) Pub. Date: Mar. 12, 2020

(54) Coaxial Resonator and Method of Operating a Coaxial Resonator

(71) Applicant: Nokia Solutions and Networks Oy, Espoo (FI)

(72) Inventors: Kimmo Karhu, Oulu (FI); Matias llmonen, Liminka (FI); Kimmo Ervasti, Varjakka (FI)

(21) Appl. No.: 16/559,785

(22) Filed: Sep. 4, 2019

(30) Foreign Application Priority Data
Sep. 7, 2018 (EP) 18193284.9

(51) Int. Cl. H01P 7/04; H01P 7/06; H01P 1/208; H01P 1/205; H01P 1/30

(52) U.S. Cl. CPC H01P 7/04; H01P 7/06; H01P 1/30; H01P 1/2053; H01P 1/208

(57) ABSTRACT

A coaxial resonator for radio frequency, RF, signals, said resonator comprising a cavity, the cavity comprising a first wall, a second wall opposite the first wall, and at least one side wall, the resonator further comprising a first post extending with its longitudinal axis into the cavity from said first wall, wherein an outer diameter of at least a first axial section of said first post is, preferably reversibly, changeable.

### TECHNICAL FIELD

The disclosure relates to a coaxial resonator for radio frequency, RF, signals. The disclosure further relates to a method of operating such resonator.

### BACKGROUND

Coaxial resonators can e.g. be used in filters for base stations of (cellular) communication systems, where RF signals may be processed that may comprise a comparatively high signal power, e.g. in a Tx (transmit) path.

### SUMMARY

Exemplary embodiments relate to a coaxial resonator for radio frequency, RF, signals, said resonator comprising a cavity, the cavity comprising a first wall, a second wall opposite the first wall, and at least one side wall, the resonator further comprising a first post extending with its longitudinal axis into the cavity from said first wall, wherein an outer diameter of at least a first axial section of said first post is changeable. This advantageously enables to influence an impedance of the resonator. According to Applicant's analysis, influencing an impedance of the resonator this way may e.g. be used to tune the resonator, especially with respect to its resonance frequency. In other words, preferred embodiments enable to tune the resonance frequency of a coaxial resonator by changing an outer diameter of said at least a first axial section of said first post. This enables efficient and flexible frequency tuning which may e.g. be used to compensate for mechanical tolerances and/or material parameter tolerances of any component of the resonator.

According to further exemplary embodiments, said outer diameter of at least a first axial section of said first post is reversibly changeable. As an example, according to further exemplary embodiments, said outer diameter may be changed from a first value to a second value, which is different from said first value, and may then be changed to a third value, which may be substantially identical to the first value, or which may be different from said first and said second value, and so forth. This also enables efficient and flexible frequency tuning which may e.g. be used to compensate for mechanical tolerances and/or material parameter tolerances of any component of the resonator. Also, a temperature influence may be compensated by the tuning enabled by the embodiments.

According to further exemplary embodiments, said first post may e.g. comprise a cylindrical, preferably circular cylindrical, shape. This means that the first post may have a basic shape which is cylindrical, and that according to further embodiments deviations from a strict cylindrical shape in a geometrical sense are possible.

According to further exemplary embodiments, said cavity may also comprise a cylindrical, preferably circular cylindrical, shape. In case of a circular cylindrical shape of the cavity there may be one (single) side wall providing a closed resonator cavity together with said first and second walls, which may, according to further embodiments, e.g. represent a top wall or “lid” and a bottom wall.

According to further exemplary embodiments, the cavity may also comprise cuboid shape.

According to further exemplary embodiments, the first axial section of the first post, the diameter of which is changeable, may be a first axial end section, or a second end axial end section. According to further exemplary embodiments, the first axial section of the first post, the diameter of which is changeable, is an intermediate axial section arranged between said first and second axial end sections.

As an example, a second axial end section of the first post may be arranged at an inner surface of the first wall of the cavity, and the first axial section of the first post, the diameter of which is changeable, may be said first axial end section which protrudes in the interior of the cavity.

According to further exemplary embodiments, said first post may have at least one further axial section an outer diameter of which is changeable, in addition to the first axial section.

According to further exemplary embodiments, said first axial section of said first post is deformable (e.g., to effect a change of said outer diameter), wherein an efficient tuning of an impedance of the resonator and thus its resonance frequency is enabled.

According to further exemplary embodiments, said first axial section of said first post is elastically deformable (in contrast to plasticity). This means that, starting from a non-deformed initial state with a predetermined initial outer diameter, said first axial section of said first post may be deformed, e.g. by applying a force to said axial section of said first post, thus attaining a first deformed state with a different outer diameter, as compared to the initial outer diameter, and that said axial section of said first post will substantially return to its non-deformed initial state with said initial outer diameter once the force is not applied any more.

According to further exemplary embodiments, said first axial section of said first post comprises at least one deformable element. As an example, the first post may comprise a first component, and at least one deformable element may be attached to said first component to provide said first axial section. According to further exemplary embodiments, the deformable element may comprise an elastically deformable material, which e.g. comprise an electrically conductive surface or surface layer (e.g., coating), respectively. According to further exemplary embodiments, said electrically conductive surface layer comprises a thickness equal to or greater than a skin depth of the signal frequencies processed by said resonator.

According to further exemplary embodiments, said at least one deformable element is deformable by applying a force to an axial front surface of said at least one deformable element, which enables efficient deformation and thus tuning of the resonator.

According to further exemplary embodiments, said at least one deformable element is hollow and is deformable by applying a force to a radially inner surface. As an example, if the force is at least partially directed in a radially outer direction, the outer diameter of the hollow deformable element may be changed.

According to further exemplary embodiments, an actuating element is provided, e.g. at the second wall, wherein said actuating element is movable at least in an axial direction with respect to a longitudinal axis of said first post, particularly to exert an actuating force on said at least one deformable element. According to further exemplary embodiments, the second wall may comprise an opening for receiving and/or guiding said actuating element. According to further exemplary embodiments, the second wall may also comprise a thread, and the actuating element may comprise a corresponding threaded section enabling to screw the actuating element into said second wall thus also effecting an axial movement of the actuating element.

According to further exemplary embodiments, the actuating element may comprise or consist of electrically conductive material. According to further exemplary embodiments, the actuating element may comprise or consist of electrically non-conductive (i.e., dielectric) material.

According to further exemplary embodiments, said at least one deformable element comprises a solid body (e.g. an elastically deformable solid body) and/or a plurality of flexible sheets (e.g., one or more pieces of sheet metal) and/or a plurality of flexible wires.

According to further exemplary embodiments, said at least one deformable element may be deformable by applying fluid pressure, e.g. gas pressure, e.g. air pressure, to it. According to further exemplary embodiments, said at least one deformable element may be compressible by gas pressure, e.g. air pressure. In some embodiments, the cavity of the resonator may be gas tight, e.g. air tight, and a gas pressure, e.g. air pressure, in the cavity may be controllable to influence the degree of deformation of the deformable element. According to further exemplary embodiments, said at least one deformable element may comprise a hollow gas tight, e.g. air-tight, structure, and a gas pressure within said hollow structure may be controlled to influence the degree of deformation of the deformable element. According to further exemplary embodiments, an automated tuning may be performed by automated control of the gas pressure influencing the degree of deformation of the deformable element (e.g., the gas pressure within the cavity and/or the gas pressure within the hollow structure of the deformable element).

According to further exemplary embodiments, said deformable element comprises a first element and a second element arranged at a first distance from said first element and rotatably with respect to said first element, and at least one connecting element connecting said first element and said second element. By rotating the first element with respect to the second element, a shape of said at least one connecting element may be altered which may also effect a change of an effective outer diameter of said deformable element.

According to further exemplary embodiments, said first axial section comprises a first outer diameter, wherein at least a first hollow cylindrical element having a second outer diameter, which is greater than said first outer diameter, is axially movable with respect to said first axial section. This way, a further possibility to change the outer diameter of the first axial section is provided. According to further exemplary embodiments, more than one hollow cylindrical element may also be used to enable further steps of tuning the resonance frequency of the resonator by influencing its impedance.

According to further exemplary embodiments, said first post comprises electrically conductive material and/or at least a surface layer of electrically conductive material. According to further exemplary embodiments, said surface layer of said first post comprises a thickness equal to or greater than a skin depth of the signal frequencies of the RF signals processed by said resonator.

According to further exemplary embodiments, said at least one deformable element comprises an electrically conductive surface or surface layer. According to further exemplary embodiments, said surface layer of said at least one deformable element comprises a thickness equal to or greater than a skin depth of the signal frequencies of the RF signals processed by said resonator.

According to further exemplary embodiments, said resonator comprises a second post extending with its longitudinal axis into the cavity from said second wall. As an example, the first post may represent a resonator post of the coaxial resonator, and the second post may be used as a capacitive load element for capacitively loading said resonator, or vice versa.

I.e., according to further exemplary embodiments, said first post may represent a capacitive load element (“capacitive loading post”), and the second post may form a resonator post. In this case, the capacitive load element may be tunable by changing the outer diameter of at least one of its axial sections according to the principle of the embodiments.

According to further exemplary embodiments, said resonator comprises a dielectric element arranged between said first post and said second post, said dielectric element e g making contact with the respective front faces of the first and second post, whereby a maximum value of the electric (“E-”) field may be reduced, as compared to an air gap between said respective front faces of the first and second post.

According to further exemplary embodiments, an outer diameter of at least a first axial section of said second post is changeable. According to further exemplary embodiments, said outer diameter of at least a first axial section of said second post is reversibly changeable. In this regard, according to further exemplary embodiments, the principle of the embodiments as explained above may also be applied to the second post. This way, further degrees of (resonance frequency) tuning of the resonator are obtained.

According to further exemplary embodiments, if more than one post is provided in the resonator cavity, at least one of said posts (either resonator post or (capacitive) loading post or any other type of post) may comprise a changeable outer diameter section.

Further exemplary embodiments feature a filter for radio frequency, RF, signals, comprising at least one resonator according to the embodiments. Such filter may e.g. be used in radio modules or remote radio heads (RRH) of communication systems, e.g. base stations of cellular communication systems, particularly in a Tx path of these components and/or systems.

Further exemplary embodiments feature a method of operating a coaxial resonator for radio frequency, RF, signals, said resonator comprising a cavity, the cavity comprising a first wall, a second wall opposite the first wall, and at least one side wall, the resonator further comprising a first post extending with its longitudinal axis into the cavity from said first wall, wherein an outer diameter of at least a first axial section of said first post is changeable, wherein said method comprises the following steps: operating said resonator in a first operational state wherein said outer diameter comprises a first value, changing said outer diameter to a second value, which is different from said first value.

According to further exemplary embodiments, said outer diameter of said first axial section of said first post is reversibly changeable.

According to exemplary embodiments, said method may further comprise: operating said resonator in a second operational state wherein said outer diameter comprises said second value. As an example, the first operational state may be regarded as an untuned state, wherein a resonance frequency of the resonator does not have the desired target value, and the second operational state may be regarded as a tuned state, wherein the resonance frequency of the resonator does have the desired target value, due to the tuning step represented by the changing of said outer diameter to said second value.

Further advantageous embodiments of said method are provided by the dependent claims.

### BRIEF DESCRIPTION OF THE FIGURES

Further features, aspects and advantages of the illustrative embodiments are given in the following detailed description with reference to the drawings in which:

FIG. 1 schematically depicts a partial cross-sectional side view of a resonator according to an embodiment,

FIG. 2A schematically depicts a partial cross-sectional side view of a resonator according to a further embodiment in a first operational state,

FIG. 2B schematically depicts the resonator of FIG. 2A in a second operational state,

FIG. 3A schematically depicts a partial cross-sectional side view of a resonator according to a further embodiment in a first operational state,

FIG. 3B schematically depicts the resonator of FIG. 3A in a second operational state,

FIG. 4A schematically depicts a perspective view of a resonator according to a further embodiment in a first operational state,

FIG. 4B schematically depicts the resonator of FIG. 4A in a second operational state,

FIG. 5A schematically depicts a partial cross-sectional side view of a resonator according to a further embodiment in a first operational state,

FIG. 5B schematically depicts the resonator of FIG. 5A in a second operational state,

FIG. 6, 7, 8, 9, 10 each schematically depict a partial cross-sectional side view of a resonator according to further embodiments,

FIG. 11 schematically depicts a simplified flow-chart of a method according to an embodiment,

FIG. 12 schematically depicts a partial cross-sectional side view of a resonator according to a further embodiment,

FIG. 13 schematically depicts a top view of a filter according to an embodiment, and

FIG. 14A schematically depicts a partial cross-sectional side view of a resonator according to a further embodiment in a first operational state,

FIG. 14B schematically depicts the resonator of FIG. 14A in a second operational state.

### DETAILED DESCRIPTION

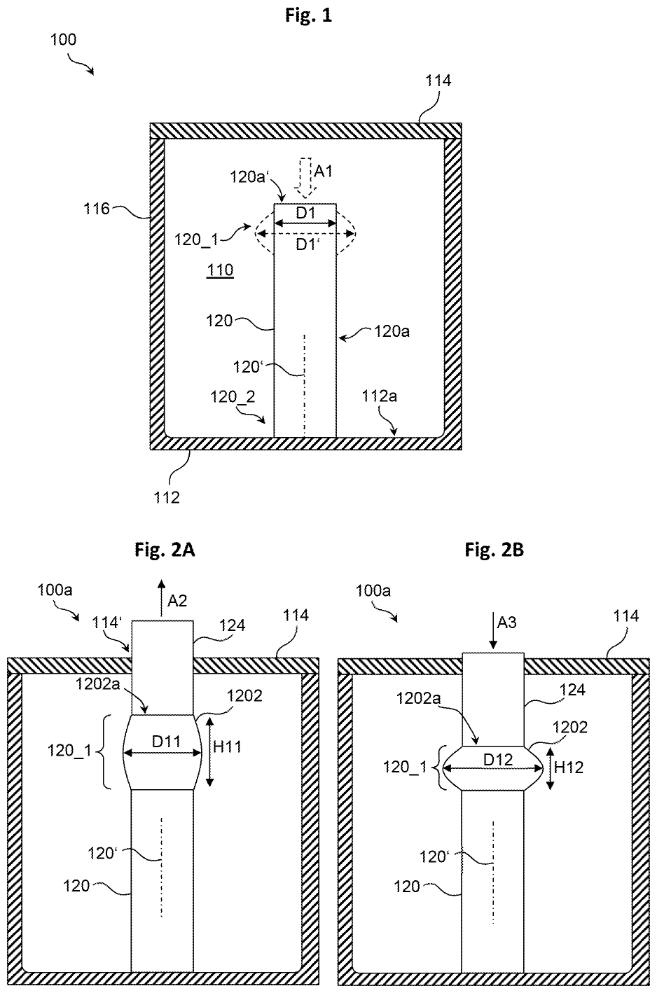

FIG. 1 schematically depicts a coaxial resonator for radio frequency, RF, signals, said resonator 100 comprising a cavity 110, the cavity 110 comprising a first wall 112 (e.g., bottom wall in the configuration as depicted by FIG. 1), a second wall 114 (e.g., top wall or lid) opposite the first wall 112, and at least one side wall 116. The resonator 100 further comprises a first post 120 extending with its longitudinal axis 120′ into the cavity 110 from said first wall 112. According to some embodiments, an outer diameter D1, D1′ of at least a first axial section 120_1 of said first post 120 is changeable. This advantageously enables to influence an impedance of the resonator 100.

According to Applicant's analysis, influencing an impedance of the resonator 100 this way may e.g. be used to tune the resonator 100, especially with respect to its resonance frequency. In other words, some embodiments enable to tune the resonance frequency of the coaxial resonator 100 by changing the outer diameter D1, D1′ of said at least first axial section 120_1 of said first post 120. This enables efficient and flexible frequency tuning which may e.g. be used to compensate for mechanical tolerances and/or material parameter tolerances of any component of the resonator 100, or a temperature compensation or the like.

According to further exemplary embodiments, said outer diameter D1, D1′ of at least a first axial section 120_1 of said first post 120 is reversibly changeable. As an example, according to further exemplary embodiments, said outer diameter D1, D1′ may be changed from a first value D1 to a second value D1′, which is different from said first value D1, and may then be changed to a third value, which may be substantially identical to the first value D1, or which may be different from said first value D1 and said second value D1′, and so forth. This also enables efficient and flexible frequency tuning which may e.g. be used to compensate for mechanical tolerances and/or material parameter tolerances of any component of the resonator. Also, a temperature influence may be compensated by the tuning enabled by the embodiments.

According to further exemplary embodiments, said first post 120 may e.g. comprise a basically cylindrical, e.g. circular cylindrical, shape. This means that the first post 120 may have a basic shape which is cylindrical (e.g. circular cylindrical), and that according to further embodiments deviations from a strict (circular) cylindrical shape in a geometrical sense are possible.

According to further exemplary embodiments, said cavity 110 may also comprise a basically cylindrical, e.g. circular cylindrical, shape. In case of a circular cylindrical shape of the cavity 110 there may be one (single) side wall 116 providing a closed resonator cavity 110 together with said first and second walls 112, 114, which may, according to further embodiments, e.g. represent a top wall or “lid” 114 and a bottom wall 112, as mentioned above. According to further exemplary embodiments (not shown), the cavity may also comprise cuboid shape.

According to further exemplary embodiments, the first axial section 120_1 of the first post 120, the diameter D1, D1′ of which is changeable, may be a first axial end section, as depicted by FIG. 1, or a second end axial end section 120_2. According to further exemplary embodiments (not shown), the first axial section of the first post 120, the diameter of which is changeable, is an intermediate axial section arranged between said first and second axial end sections 120_1, 120_2.

As an example, the second axial end section 120_2 of the first post 120 may be arranged at an inner surface 112a of the first wall 112 of the cavity 110, and the first axial section 120_1 of the first post 120, the diameter of which is changeable, may be said first axial end section which protrudes into the interior of the cavity 110.

According to further exemplary embodiments, said first post 120 may have at least one further axial section (not shown) an outer diameter of which is changeable, in addition to the first axial section 120_1.

While according to further exemplary embodiments, first post 120 may be an arbitrary post within the cavity 110 of the resonator, for the further explanations it is exemplarily assumed that said first post 120 represents a resonator post coaxially arranged with respect to said cavity 110. In these cases, said resonator post 120 (or its axial section 120_1) is tunable due to the outer diameter change as explained.

However, according to further exemplary embodiments, said first post 120 may also represent a capacitive loading post or the like, and may optionally also be arranged non-coaxially (not shown) with respect to the cavity 110, i.e. with its longitudinal axis 120′ being different from a longitudinal axis (not shown) of the cavity 110. In these cases, a tunable (due to outer diameter change) capacitive loading post may be provided.

According to further exemplary embodiments, said first axial section 120_1 of said first post 120 is deformable, cf. the dashed lines of FIG. 1, which exemplarily illustrate a deformed state with an increased outer diameter D1′, as compared to an undeformed state with an initial outer diameter D1. According to some embodiments, such deformation may e.g. be attained by applying a force A1 to the deformable first axial section 120_1. This way, an efficient tuning of an impedance of the resonator 100 and thus its resonance frequency is enabled.

According to further exemplary embodiments, said first axial section 120_1 of said first post 120 is elastically deformable (in contrast to plasticity). This means that, starting from a non-deformed initial state with a predetermined initial outer diameter D1, said first axial section 120_1 of said first post 120 may be deformed, e.g. by applying a force A1 to said first axial section 120_1 (e.g., the front face 120a′) of said first post 120, thus attaining a first deformed state with a different outer diameter D1′, as compared to the initial outer diameter D1, and that said first axial section 120_1 of said first post 120 will substantially return to its non-deformed initial state with said initial outer diameter D1 once the force A1 is not applied any more.

According to further exemplary embodiments, said first axial section 120_1 of said first post 120 comprises at least one deformable element 1202, cf. the embodiment of the resonator 100a as depicted by FIG. 2A, 2B. As an example, the state depicted by FIG. 2A may be regarded as an initial state wherein said deformable element 1202 is not deformed, comprising a height H11 and an outer diameter D11, and the state depicted by FIG. 2B may be regarded as a deformed state wherein said deformable element 1202 is deformed, comprising a height H12<H11 and an outer diameter D12>D11, leading to another impedance and thus also resonance frequency of the resonator 100a, as compared to the initial state of FIG. 2A.

As an example, the first post 120 may comprise a first component, and said at least one deformable element 1202 may be attached to said first component to provide said first axial section 120_1. According to further exemplary embodiments, the deformable element 1202 may comprise an elastically deformable material, which e.g. comprise an electrically conductive surface or surface layer (e.g., coating), respectively. According to further exemplary embodiments, said electrically conductive surface layer comprises a thickness equal to or greater than a skin depth of the signal frequencies processed by said resonator 100a.

According to further exemplary embodiments, said at least one deformable element 1202 is deformable by applying a force A3 (FIG. 2B) to an axial front surface 1202a of said at least one deformable element 1202, which enables efficient deformation and thus tuning of the resonator 100a. Herein the term “front” refers to a side 1202a of the deformable element 1202 that faces the direction of the force A3 and receives such force when applied.

By choosing a value of the force A3 (FIG. 2B), a degree of deformation of the deformable element 1202 and thus the change of its outer diameter D11, D12 may be determined. In other words, depending on the absolute value of the force A3, a wide range of different resulting outer diameters of the deformable element 1202 and thus a wide tuning range for the resonance frequency of the resonator 100a may be attained. In the absence of the force A3, however, cf. arrow A2 of FIG. 2A, the resonator returns to its initial state.

According to further exemplary embodiments, an actuating element 124 is provided, for example at the second wall 114, wherein said actuating element 124 is movable at least in an axial direction with respect to a longitudinal axis 120′ of said first post 120, particularly to exert an actuating force A3 on said at least one deformable element 1202. According to further exemplary embodiments, the second wall 114 may comprise an opening 114′ for receiving and/or guiding said actuating element 124. According to further exemplary embodiments, the second wall 114 may also comprise a thread (not shown), and the actuating element 124 may comprise a corresponding threaded section (not shown) enabling to screw the actuating element 124 into said second wall 114 or its opening 114′ thus also effecting an axial movement of the actuating element 124. The actuating element 124 enables efficient tuning of the resonator 100a from the outside, so that the cavity 110 is not required to be opened for said tuning.

According to further exemplary embodiments, the actuating element 124 may comprise or consist of electrically conductive material. According to further exemplary embodiments, the actuating element 124 may comprise or consist of electrically non-conductive (i.e., dielectric) material.

According to further exemplary embodiments, said at least one deformable element 1202 comprises a solid body (e.g. an elastically deformable solid body) and/or a plurality of flexible sheets (e.g., one or more pieces of sheet metal) and/or a plurality of flexible wires.

According to further exemplary embodiments, said at least one deformable element 1202 may be deformable by applying fluid pressure, e.g. gas pressure, e.g. air pressure, to it. According to further exemplary embodiments, said at least one deformable element 1202 may be compressible by gas pressure, e.g. air pressure. In some embodiments, the cavity 110 of the resonator 100a may be gas tight, e.g. air tight, and a gas pressure, e.g. air pressure, in the cavity 110 may be controllable to influence the degree of deformation of the deformable element 1202.

According to further exemplary embodiments, said at least one deformable element 1202 may comprise a hollow gas tight, e.g. air-tight, structure, and a gas pressure within said hollow structure may be controlled to influence the degree of deformation of the deformable element. According to further exemplary embodiments, an automated tuning may be performed by automated control of the gas pressure influencing the degree of deformation of the deformable element 1202 (e.g., the gas pressure within the cavity 110 and/or the gas pressure within the hollow structure of the deformable element 1202).

As an example, FIG. 14A schematically depicts a partial cross-sectional side view of a resonator 100l according to a further embodiment in a first operational state, and FIG. 14B schematically depicts the resonator 100l of FIG. 14A in a second operational state.

A pressure supply 160 provides pressurized gas, e.g. air, wherein the pressure of the pressurized air may e.g. be controlled in a per se known manner. The pressurized air is provided to a duct section 165 of the cavity 110 of the resonator 100l via a tube 162, which is connected to an opening 164 in the top wall 114 of the resonator 100l. As an example, the deformable element 1209 is formed by a hollow, gas tight (e.g., air tight) structure, e.g. having an electrically conductive outer surface 1209a. Pressurized air may be provided to an interior of said deformable element 1209 via said duct 165, cf. double block arrow 166, so that a fluid pressure, e.g. air pressure, in the interior of said deformable element 1209 may be controlled (e.g., increased or decreased). This way, the outer diameter D11′ of the deformable element 1209 may be influenced, whereby the resonance frequency of the resonator 100l may be tuned. FIG. 14A shows a first operational state of the resonator 100l, wherein a comparatively low first air pressure is provided to the interior of the deformable element 1209, effecting the outer diameter D11′, whereas FIG. 14B shows a second operational state of the resonator 100l, wherein a higher second air pressure is provided to the interior of the deformable element 1209, effecting the increased outer diameter D12′>D11′. By providing different ranges of air pressure values, different corresponding outer diameters of the element 1209 may be provided according to further exemplary embodiments. According to further exemplary embodiments, an automated tuning of resonator 100l may be effected by providing an automatic control of the air pressure as provided by supply 160.

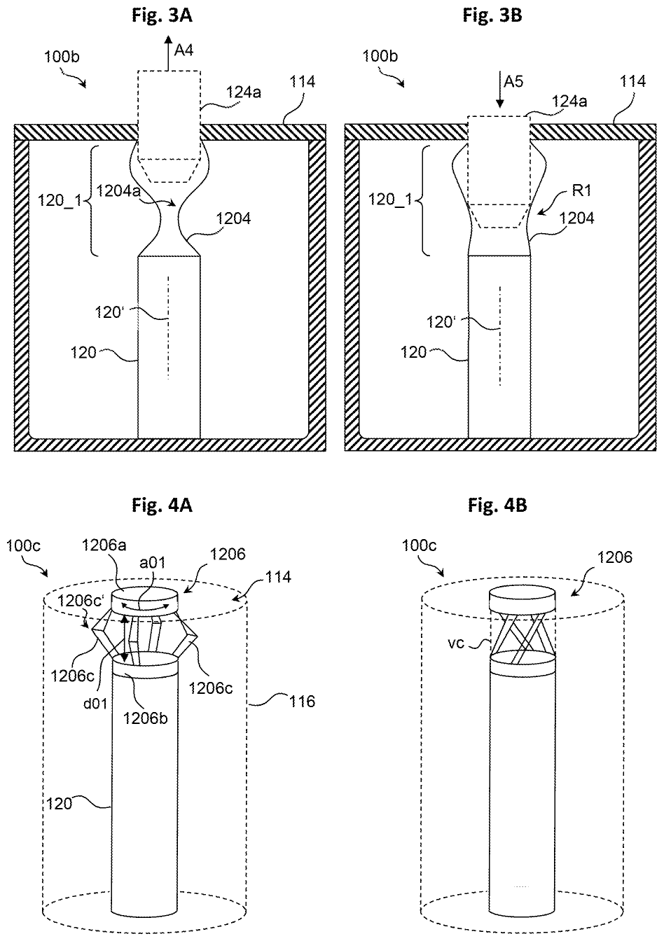

FIG. 3A schematically depicts a partial cross-sectional side view of a resonator 100b according to a further embodiment in a first operational state, and FIG. 3B schematically depicts the resonator 100b of FIG. 3A in a second operational state. In the exemplary configuration 100b, said at least one deformable element 1204 is hollow and is deformable by applying a force to a radially inner surface 1204a. As an example, if the force is at least partially directed in a radially outer direction, the outer diameter of the hollow deformable element 1204 may be changed in the sense of the principle according to the embodiments.

As shown on FIG. 3A, an actuating element 124a similar to element 124 of FIG. 2A, 2B is provided, wherein an axial movement A5 (FIG. 3B) effects an increase of the outer diameter of the hollow deformable element 1204, which is due to a resulting force directed radially outwards in region R1 of the hollow deformable element 1204 provided by said actuating element 124a. As an example, the hollow deformable element 1204 may—in its initial state, cf. FIG. 3A—e.g. substantially comprise an hourglass-shaped cross-section, which may gradually be expanded to the configuration as depicted by FIG. 3B by axial insertion of the actuating element 124a into said element 1204. Optionally, a tip of the actuating element 124a may be conical, or of other suitable form, to provide for a smooth expansion of the element 1204. Retracting the actuating element 124a, cf. arrow A4 of FIG. 3A, enables to attain the initial state or shape of the element 1204 due to its elastic properties.

According to further exemplary embodiments, said at least one deformable element 1204 comprises a plurality of flexible sheets (e.g., one or more pieces of sheet metal) and/or a plurality of flexible wires, which may form a body having substantially the cross-section 1204 as depicted by FIG. 3A.

According to further exemplary embodiments of the resonator 100c, two operating states of which are depicted by FIG. 4A, 4B, said deformable element 1206 comprises a first (substantially disc-shaped) element 1206a and a second element 1206b arranged at a first distance d01 from said first element 1206a and rotatably (cf. double arrow a01) with respect to said first element 1206a, and at least one (e.g. four, as shown) connecting element(s) 1206c connecting said first element 1206a and said second element 1206b. By rotating the first element 1206a with respect to the second element 1206b (or vice versa), a shape of said at least one connecting element 1206c may be altered (e.g., between an elongated state (FIG. 4B) and a compressed state (FIG. 4A)) which may also effect a change of an effective outer diameter of said deformable element 1206. As can be seen from FIG. 4A, in the compressed state, intermediate sections 1206c′ of the connecting elements 1206c protrude through a side surface of a virtual circular cylinder vc (cf. FIG. 4B) defined by said elements 1206a, 1206b thus effecting an increased effective outer diameter of the element 1206, as compared to the elongated state of FIG. 4B.

According to further exemplary embodiments, the first element 1206a may be used as actuation element for tuning, which may e.g. be integrated in a suitable opening of the lid 114 so that a degree of relative rotation of said first element 1206a may be determined by directly turning, i.e. rotating, said first element 1206a from outside of the cavity 110.

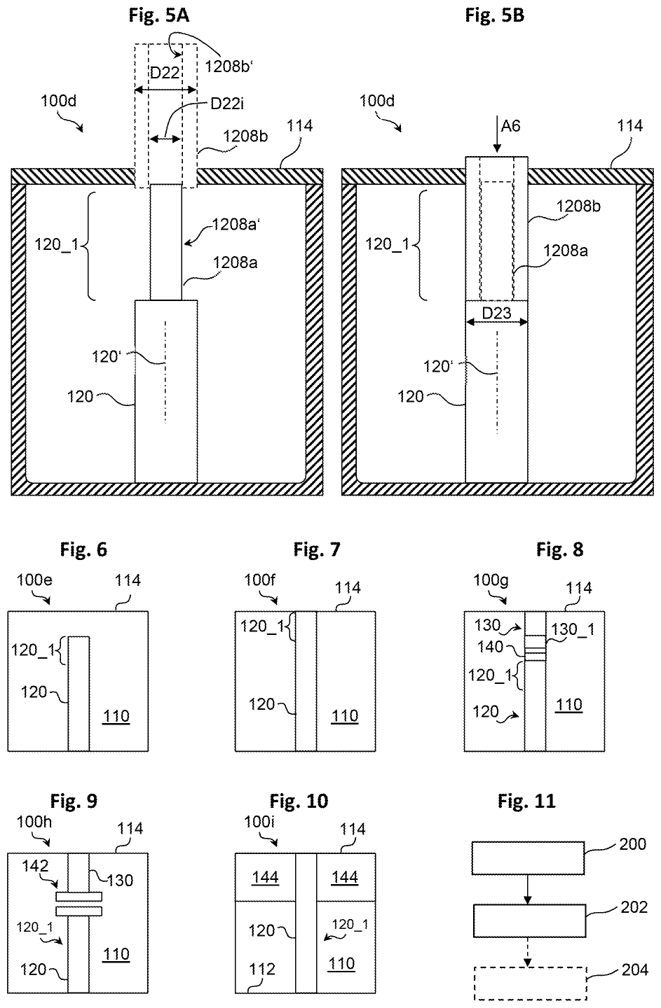

FIG. 5A schematically depicts a partial cross-sectional side view of a resonator 100d according to a further embodiment in a first operational state, and FIG. 5B schematically depicts the resonator 100d of FIG. 5A in a second operational state. In the exemplary configuration 100d, said first axial section 120_1, having circular cylindrical shape 1208a, comprises a first outer diameter D21, wherein at least a first hollow cylindrical (e.g., tubular) element 1208b having a second outer diameter D22, which is greater than said first outer diameter D21, is axially movable over said first axial section 120_1. This way, a further possibility to change the outer diameter of the first axial section 120_1 and thus influencing the impedance and resonance frequency of the resonator 100d is provided. According to further exemplary embodiments, the geometry of the tubular element 1208b is adapted to the geometry of the first axial section 120_1 such that electrically conductive contact between elements 1208a, 1208b is made if said tubular element 1208b is moved over the shape 1208a. According to further exemplary embodiments, an inner diameter D22i of the tubular element 1208b may be chosen with respect to the first outer diameter D21 such that an electrically conductive contact between elements 1208a, 1208b, e.g. between the radially inner surface 1208b′ of element 1208b and the radially outer surface 1208a′ of element 1208a is made if said tubular element 1208b is moved over the shape 1208a.

According to further exemplary embodiments, more than one hollow cylindrical element 1208b may also be used to enable further steps of tuning the resonance frequency of the resonator 100d by influencing its impedance.

Similar to the configurations of FIG. 2A, 3A, the resonator 100d of FIG. 5A, 5B may comprise an opening in the second wall 114 to enable insertion A6 (FIG. 5B) of the hollow cylindrical element 1208b into the cavity 110. The hollow cylindrical element 1208b may be made of electrically conductive material or comprises an electrically conductive surface layer, which may be electrically conductively connected to the second wall 114, e.g. in the area of the opening (not shown).

According to further exemplary embodiments, the outer diameter D22 (FIG. 5A) of the hollow cylindrical element 1208b may be substantially equal to the outer diameter D23 of the other portions of the first post 120. According to further exemplary embodiments, however, the outer diameter D22 (FIG. 5A) of the hollow cylindrical element 1208b may also be different from the outer diameter D23 of said other portions of the first post 120.

According to further exemplary embodiments, said first post 120 comprises electrically conductive material and/or at least a surface layer of electrically conductive material. According to further exemplary embodiments, said surface layer of said first post comprises a thickness equal to or greater than a skin depth of the signal frequencies of the RF signals processed by said resonator.

According to further exemplary embodiments, said at least one deformable element 1202, 1204, 1206 comprises an electrically conductive surface or surface layer. According to further exemplary embodiments, said surface layer of said at least one deformable element comprises a thickness equal to or greater than a skin depth of the signal frequencies of the RF signals processed by said resonator.

The principle according to the embodiments explained above with respect to FIGS. 1 to 5B may be applied to a wide variety of types of resonators, particularly coaxial resonators.

According to further exemplary embodiments, a quarter wavelength coaxial resonator 100e, cf. FIG. 6, is provided. Said quarter wavelength coaxial resonator 100e comprises a first post 120, which may e.g. be a resonator post, wherein an outer diameter of at least a first axial section 120_1 of said resonator post 120 is changeable in accordance with the principle according to the embodiments explained above.

According to further exemplary embodiments, a half wavelength coaxial resonator 100f, cf. FIG. 7, is provided. Said half wavelength coaxial resonator 100f comprises a first post 120, which may e.g. be a resonator post, wherein an outer diameter of at least a first axial section 120_1 of said resonator post 120 is changeable in accordance with the principle according to the embodiments explained above.

According to further exemplary embodiments, a capacitively loaded coaxial resonator 100g, cf. FIG. 8, is provided, which comprises a first post 120, which again forms a resonator post. An outer diameter of at least a first axial section 120_1 of said resonator post 120 is changeable in accordance with the principle according to the embodiments explained above. Additionally, the resonator 100g of FIG. 8 comprises a second post 130 extending with its longitudinal axis into the cavity 110 from the second wall 114. The second post 130 effects a capacitive load on the resonator 100g.

Optionally, the resonator 100g may comprise a dielectric element 140 arranged between said first post 120 and said second post 130, said dielectric element 140 may be making contact with the respective front faces of the first and second post, whereby a maximum value of the electric (“E-”) field in this region may be reduced, as compared to an air gap between said respective front faces of the first and second post.

According to further exemplary embodiments, an outer diameter of at least a first axial section 130_1 of said second post 130 of the resonator 100g is changeable. In this regard, according to further exemplary embodiments, the principle of the embodiments as explained above may also be applied to the second post 130. This way, further degrees of (resonance frequency) tuning of the resonator 100g are obtained.

According to further embodiments, it is also possible to provide said first post 120 as a conventional (i.e., non-tunable) resonator post 120, and said second post 130 as a tunable post according to the principle of the embodiments.

According to further exemplary embodiments, a capacitively loaded coaxial resonator 100h, cf. FIG. 9, is provided, which comprises a first post 120 (resonator post), a second post 130 (capacitive load), and an additional capacitor structure 142 formed between opposing front surfaces of the posts 120, 130. At least one of said posts 120, 130 may comprise at least one axial section 120_1 with a changeable outer diameter in accordance with the principle of the embodiments explained above.

According to further exemplary embodiments, a partially dielectric loaded coaxial resonator 100i, cf. FIG. 10, is provided, which comprises a first (resonator) post 120 extending through the cavity 110 from the first (bottom) wall 112 to the second (top) wall 114. The cavity 110 is partly filled with dielectric material 144. Also with this configuration 100i, the resonator post 120 may comprise at least one axial section 120_1 with a changeable outer diameter in accordance with the principle of the embodiments explained above.

Further exemplary embodiments feature a method of operating a coaxial resonator 100, 100a, 100b, . . . , 100i for radio frequency, RF, signals, said resonator comprising a cavity 110 (FIG. 1), the cavity comprising a first wall 112, a second wall 114 opposite the first wall 112, and at least one side wall 116, the resonator further comprising a first post 120 extending with its longitudinal axis 120′ into the cavity 110 from said first wall 112, wherein an outer diameter D1 of at least a first axial section 120_1 of said first post 120 is changeable, wherein said method comprises the following steps, cf. FIG. 11: operating 200 said resonator in a first operational state wherein said outer diameter comprises a first value D1 (FIG. 1), changing 202 (FIG. 11) said outer diameter to a second value D1′, which is different from said first value D1.

According to further exemplary embodiments, said method may further comprise: operating 204 said resonator in a second operational state wherein said outer diameter comprises said second value D1′. As an example, the first operational state may be regarded as an untuned state, wherein a resonance frequency of the resonator does not have a desired target value, and the second operational state may be regarded as a tuned state, wherein the resonance frequency of the resonator does have the desired target value, due to the tuning step 202 represented by the changing of said outer diameter to said second value Dr. Of course, according to further exemplary embodiments, tuning and operating steps may be repeated and/or provided in any other sequence.

According to further exemplary embodiments, depending on a force applied to the deformable first axial section 120_1 (FIG. 1) and/or the deformable element 1202, 1204, 1204, a degree of deformation and thus change of its outer diameter may be precisely controlled, so that a precise tuning of the resonance frequency of the resonator according to the embodiments is enabled, whereby mechanical tolerances and/or material parameter tolerances and/or temperature variations and the like may be compensated.

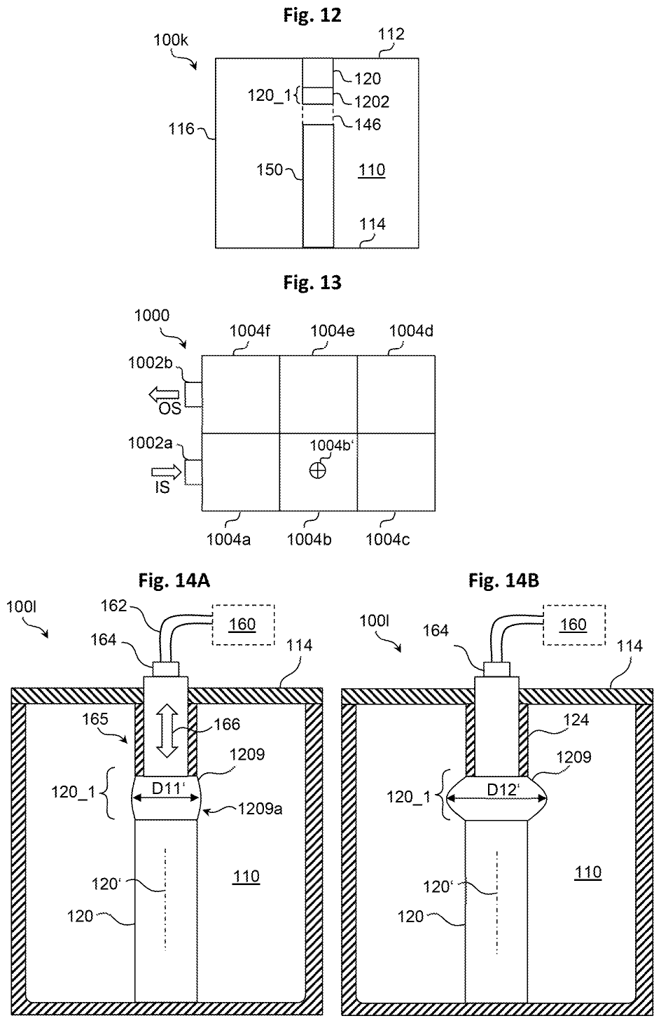

FIG. 12 schematically depicts a dielectric loaded coaxial resonator 100k according to a further exemplary embodiment. In this configuration 100k and according to FIG. 12, the first wall 112 is a top wall (e.g., lid), the second wall 114 is a bottom wall, the resonator 100k further having at least one side wall 116 (in case of a circular cylindrical cavity 110 e.g. exactly one side wall, whereas in case of a cuboid shape (not shown) of the cavity, four side walls may be provided). The resonator 100k further comprises a first post 120 extending into the cavity 110 from the top wall, the first post 120 comprising at least one axial section 120_1 with a changeable outer diameter in accordance with the principle of the embodiments explained above. As an example, the first post 120 of resonator 100k may comprise a deformable element 1202 identical or similar to the element 1202 explained above with respect to FIG. 2A, 2B. The resonator 100k comprises a further post 150 extending into the cavity 110 from the bottom wall 114. As an example, the further post 150 may constitute a resonator post of the resonator 100k, while the first (tunable) post 120 may represent a capacitive load (“loading post”). Optionally, a dielectric element 146 may be provided between the opposing front surfaces of the posts 120, 150 to reduce the E-field therebetween.

Further exemplary embodiments, cf. the top view of FIG. 13, feature a filter 1000 for radio frequency, RF, signals, comprising at least one resonator 100, 100a, 100b, . . . , 100k according to the embodiments. Such filter 1000 may e.g. be used in radio modules or remote radio heads (RRH) of communication systems, e.g. base stations of cellular communication systems, particularly in a Tx path of these components and/or systems.

As exemplary shown, the filter 1000 comprises six resonators 1004a, 1004b, 1004c, 1004d, 1004e, 1004f, an input port 1002a for providing an (RF) input signal IS to the filter 1000, and an output port 1002b for providing a filtered (RF) output signal OS. As an example, said filter 1000 may be provided in a transmit path of a base station of a cellular communications network, e.g. for filtering an RF signal which is to be transmitted via an air interface comprising one or more antennas. According to further exemplary embodiments, at least one of said six resonators 1004a, 1004b, 1004c, 1004d, 1004e, 1004f comprises a configuration as explained above with reference to FIG. 1 to FIG. 12, thus enabling efficient tuning of the respective resonator(s). According to further exemplary embodiments, any of the six resonators 1004a, 1004b, 1004c, 1004d, 1004e, 1004f may be coupled with at least one neighboring resonator of the filter 1000 thus enabling RF signals to propagate therebetween, which may be desired for attaining a desired filter characteristic.

As an example, resonator 1004b of the filter 1000 comprises a structure similar to the configuration 100c of FIG. 4A, wherein reference sign 1004b′ of FIG. 13 indicates an actuation element similar to rotatable element 1206a of the resonator 100c of FIG. 4A. This way, by rotating the actuation element 1004b′, the effective outer diameter of the deformable structure 1206 (FIG. 4A, 4B) of the resonator 1004b′ may be changed, thus influencing the impedance and also the resonance frequency of said resonator 1004b′. In other words, in this exemplary embodiment, too, easy and efficient resonance frequency tuning is enabled from the outside of the resonator cavity, as the actuation element 1004b′ is easily accessible in the region of the top surface of the filter 1000.

The principle according to the embodiments enables to change, particularly tune, a resonance frequency of a coaxial resonator by changing the impedance of the resonator or an optional (capacitive) loading element thereof. According to further exemplary embodiments, this may be achieved by at least partly changing a shape and/or dimension of a center conductor (e.g., first post 120) and/or by changing a shape or dimension of the optional loading element (e.g., post 130 of FIG. 8 or post 120 of FIG. 12), thus effecting a change of outer diameter of the respective components, which leads to a change of impedance, which, in turn leads to a change of the resonance frequency of the resonator.

In the following, further aspects according to further exemplary embodiments are explained.

With some coaxial resonators, problems may exist when such a coaxial resonator is very strongly capacitively loaded. Such strong capacitive loading may e.g. be required when available room for a filter comprising said resonator or available room for said resonator is low. According to exemplary embodiments, capacitive loading of the resonator may shift the resonance frequency to lower frequencies. According to further exemplary embodiments, this capacitive loading can be done by a large air insulated plate capacitor type structure (cf. reference sign 142 of FIG. 9) or by a high dielectric constant ceramic part (e.g., element 140 of FIG. 8).

A high fixed (or static) capacitive load, however, means that (additional) capacitive loading for tuning purposes, as may provided by a capacitive tuning element, may not work effectively to get a good tuning effect (e.g., tuning range) like >2% of resonance frequency. In other words, if a high static capacitive load is provided to a resonator, e.g. due to building room restrictions, additional capacitive tuning may have a very limited effect.

According to further exemplary embodiments, a required tuning range (e.g., a frequency range within which a resonance frequency of a coaxial resonator may be changed, i.e. tuned) may depend on design and mechanical tolerances of parts and assemblies of the resonator.

Problems with capacitive tuning may become especially emphasized in Tx filters due to comparatively large signal energy that has to be handled in a Tx path. On the other hand, a large tuning range may require low air gaps between a tuning element and resonator, e.g. between opposing front surfaces of a resonator post 150 (FIG. 12) and a tunable loading post 120 (FIG. 12). Low air gap means that E-field strengthens between resonator post 150 and the tuning element 120, and high E-field values may increase a voltage breakdown risk especially in resonators for multicarrier or (other) high power transmitter filters.

Problems may also exist when half-wavelength resonators are used. E-field maximum is in a middle of cavity and capacitive loading to there is difficult to arrange.

In view of these aspects, according to further exemplary embodiments, is has been found that a resonance frequency in air filled or partially air filled coaxial resonator depends on an impedance of the resonator, among other dimensions and a capacitive load. According to Applicant's analysis, the impedance of the resonator may depend on a ratio of a diameter of an outer conductor and an inner conductor.

According to further exemplary embodiments, using a linear simulator and ideal lumped elements representing a coaxial resonator, it can be confirmed that changing the outer diameter D1 (FIG. 1) of a resonator post or a capacitive loading post according to the principle of the embodiments enables an efficient tuning of the resonance frequency of the coaxial resonator. As a further example, an exemplary tuning range of about 20 MHz has been achieved by applying the principle of the embodiments in filter designs in frequency bands between 500-1000 MHz, which 20 MHz may be sufficient in many designs to compensate part tolerances and the like for said filter designs.

According to further exemplary embodiments, the shape of the cavity 110 may be fully circular in cross-section (i.e., circular cylindric), with a diameter of about 30 mm (millimeter). According to further exemplary embodiments, an outer diameter D1 of an inner conductor, e.g. represented by the first axial section 120_1 (FIG. 1) of the resonator post 120, may be changed based on the principle according to the embodiments within a range of about 5.7 mm (e.g., being associated with an impedance of about 100 Ohm) and about 9.4 mm (e.g., being associated with an impedance of about 70 Ohm). In other words, this change of the outer diameter D1 according to further embodiments enables to attain a substantial frequency tuning range via changing the impedance of the resonator.

As already explained above with reference to FIGS. 1 to 13, an impedance change of the resonator and thus also the change of its resonance frequency by influencing the outer diameter D1 (FIG. 1) according to the embodiments may be achieved in many ways in a coaxial resonator design according to the principle of the embodiments, some of which are exemplarily explained above with reference to FIGS. 1 to 13.

According to further exemplary embodiments, the first axial section 120_1 and/or the deformable element 1202, 1204, 1206 comprises electrically conductive material or at least an electrically conductive surface. According to further exemplary embodiments, these electrically conductive components are electrically conductively connected to adjacent electrically conductive components such as e.g. an electrically conductive surface 120a of the remaining post 120.

The principle according to the embodiments enables efficient frequency tuning of the resonance frequency of a coaxial resonator, especially without an adverse effect to a maximum E-field of the resonator. In view of this, the principle according to the embodiments may also be considered as enabling a “low-risk” tuning method especially for high power Tx filters. In many cases, compared to conventional approaches, the principle according to the embodiments may even improve a peak power handling capability of a coaxial resonator or a filter comprising such coaxial resonator because often the maximum E-field rises near a (conventional) capacitive tuning element, which may be avoided or omitted by using the approach enabled by the principle according to the embodiments. In effect, this means that the principle according to the embodiments enables a reduction of (especially Tx) filter size or height, compared to conventional resonators or filters, if the limiting factor of said conventional resonators or filters has been the peak power handling.

Further advantages of especially the FIG. 4A, 4B embodiment are that no separate tuning (actuating) elements are required, as element 1206a may directly be used as actuating element, e.g. being integrated within the top wall of the resonator and thus accessible from outside the cavity. This also yields cost advantages, and room can be saved because the tuning element doesn't require any room over the filter lid level, i.e. a virtual plane defined by an outer surface of the top wall 114.

Further advantages may be attained e.g. with the configuration 100g of FIG. 8. The dielectric element 140 reduces the E-field maximum value comparing to an air gap, and the tuning as enabled by the principle according to the embodiments (either using an axial section 120_1 of the post 120 and/or using an axial section 130_1 of the post 130) does not spoil the achieved level.

The principle according to the embodiments advantageously enables to provide tunable coaxial resonators and systems comprising one or more coaxial resonators such as e.g. resonator filters, as well as tuning methods, that offer a comparatively low frequency of operation and a compact size and good peak power handling.

The description and drawings merely illustrate the principles of exemplary embodiments. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of exemplary embodiments and the concepts contributed by the inventor(s) to furthering the art, and are to be construed as being without limitation to such specifically recited examples and conditions. Moreover, all statements herein reciting principles, aspects, and embodiments, as well as specific examples thereof, are intended to encompass equivalents thereof.

It should be appreciated by those skilled in the art that any block diagrams herein represent conceptual views of illustrative circuitry embodying exemplary embodiments. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

A person of skill in the art would readily recognize that steps of various above-described methods can be performed and/or controlled by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

1. A coaxial resonator for radio frequency, RF, signals, said resonator comprising a cavity, the cavity comprising a first wall, a second wall opposite the first wall, and at least one side wall, the resonator further comprising a first post extending with its longitudinal axis into the cavity from said first wall, wherein an outer diameter of at least a first axial section of said first post is changeable.

2. The resonator according to claim 1, wherein said first axial section of said first post is deformable.

3. The resonator according to claim 1, wherein said first axial section of said first post comprises at least one deformable element.

4. The resonator according to claim 3, wherein said at least one deformable element is deformable by applying a force to an axial front surface of said at least one deformable element, and/or wherein said at least one deformable element is hollow and is deformable by applying a force to a radially inner surface.

5. The resonator according to claim 3, wherein an actuating element is provided, wherein said actuating element is movable at least in an axial direction with respect to a longitudinal axis of said first post.

6. The resonator according to claim 3, wherein said at least one deformable element comprises a solid body and/or a plurality of flexible sheets and/or a plurality of flexible wires.

7. The resonator according to claim 3, wherein said deformable element comprises a first element and a second element arranged at a first distance from said first element and rotatably with respect to said first element, and at least one connecting element connecting said first element and said second element.

8. The resonator according to claim 1, wherein said first axial section comprises a first outer diameter, and wherein at least a first hollow cylindrical element having a second outer diameter, which is greater than said first outer diameter, is axially movable with respect to said first axial section.

9. The resonator according to claim 1, wherein said first post comprises electrically conductive material and/or a surface layer of electrically conductive material.

10. The resonator according to claim 3, wherein said at least one deformable element is deformable by applying fluid pressure thereto.

11. The resonator according to claim 1, wherein said resonator comprises a second post extending with its longitudinal axis into the cavity from said second wall.

12. The resonator according to claim 11, wherein said resonator comprises a dielectric element arranged between said first post and said second post.

13. The resonator according to claim 11, wherein an outer diameter of at least a first axial section of said second post is changeable.

14. A filter for radio frequency, RF, signals, comprising a coaxial resonator for radio frequency, RF, signals, said resonator comprising a cavity, the cavity comprising a first wall, a second wall opposite the first wall, and at least one side wall, the resonator further comprising a first post extending with its longitudinal axis into the cavity from said first wall, wherein an outer diameter of at least a first axial section of said first post is changeable.

15. A method of operating a coaxial resonator for radio frequency, RF, signals, said resonator comprising a cavity, the cavity comprising a first wall, a second wall opposite the first wall, and at least one side wall, the resonator further comprising a first post extending with its longitudinal axis into the cavity from said first wall, wherein an outer diameter of at least a first axial section of said first post is changeable, wherein said method comprises the following steps: operating said resonator in a first operational state wherein said outer diameter comprises a first value, changing said outer diameter to a second value, which is different from said first value.

16. The method according to claim 15, further comprising: operating said resonator in a second operational state wherein said outer diameter comprises said second value.

17. The filter according to claim 14, wherein said first axial section of said first post is deformable.

18. The filter according to claim 14, wherein said first axial section of said first post comprises at least one deformable element.

19. The filter according to claim 14, wherein said first axial section comprises a first outer diameter, and wherein at least a first hollow cylindrical element having a second outer diameter, which is greater than said first outer diameter, is axially movable with respect to said first axial section.

20. The filter according to claim 14, wherein said resonator comprises a second post extending with its longitudinal axis into the cavity from said second wall.
